(19) United States
(12) Patent Application Publication
(10) Pub. No.: US 2025/0236295 A1
(43) Pub. Date: Jul. 24, 2025

(54) TRAVELING SUPPORT CONTROLLER AND TRAVELING SUPPORT CONTROL METHOD

(71) Applicant: Mitsubishi Electric Corporation, Tokyo (JP)

(72) Inventor: Kazuhiro NISHIWAKI, Tokyo (JP)

(73) Assignee: Mitsubishi Electric Corporation, Tokyo (JP)

(21) Appl. No.: 18/959,915

(22) Filed: Nov. 26, 2024

(30) Foreign Application Priority Data
Jan. 19, 2024 (JP) 2024-006533

(51) Int. Cl. B60W 30/16; B60W 40/04

(52) U.S. Cl. CPC B60W 30/16; B60W 40/04; B60W 2554/802; B60W 2720/10; B60W 2754/30

(57) ABSTRACT

To provide a traveling support controller and a traveling support control method which can suppress excessive avoidance operation, while certainly the collision with an object in front of the ego vehicle. A traveling support controller calculates a target distance between an object which exists in front of an ego vehicle and the ego vehicle; sets a rear distance of an entry prohibition area which is set behind the object, based on a speed of the ego vehicle and the target distance; and controls the speed of the ego vehicle so that a distance between the ego vehicle and the object approaches the target distance, while preventing the ego vehicle from entering into the entry prohibition area.

### INCORPORATION BY REFERENCE

The disclosure of Japanese Patent Application No. 2024-006533 filed on Jan. 19, 2024 including its specification, claims and drawings, is incorporated herein by reference in its entirety.

### BACKGROUND

The present disclosure relates to a traveling support controller and a traveling support control method.

In recent years, the driving support system for supporting speed or steering of vehicle is put in practical use. For example, the technology of WO 2016/027347 A controls so as to avoid the collision with the object, by setting the entry prohibition area around the object, and controlling speed or steering so as not to enter into the entry prohibition area.

### SUMMARY

However, in the technology of WO 2016/027347 A, when the preceding vehicle which is traveling while maintaining a constant inter-vehicle distance decelerates, the ego vehicle immediately performs an avoidance operation so as not to enter into the entry prohibition area. Accordingly, since the ego vehicle sensitively reacts to the slight deceleration of the preceding vehicle, the riding comfort is deteriorated. When other vehicle cuts in front of the ego vehicle from the adjacent lane, the ego vehicle excessively performs the avoidance operation by deceleration or steering in order to exit from the entry prohibition area which is set in the vicinity of the ego vehicle, and the riding comfort is deteriorated.

Then, the purpose of the present disclosure is to provide a traveling support controller and a traveling support control method which can suppress excessive avoidance operation, while certainly avoiding the collision with an object in front of the ego vehicle.

A traveling support controller according to the present disclosure, including:
a target distance calculation unit that calculates a target distance between an ego vehicle and an object existing in front of the ego vehicle;
an entry prohibition area setting unit that sets an entry prohibition area at least behind the object; and
a vehicle control unit that controls a speed of the ego vehicle so that a distance between the ego vehicle and the object approaches the target distance, while preventing the ego vehicle from entering into the entry prohibition area,
wherein the entry prohibition area setting unit sets a rear distance of the entry prohibition area which is set behind the object, based on the speed of the ego vehicle and the target distance.

A traveling support control method according to the present disclosure, including:
a target distance calculation step of calculating a target distance between an ego vehicle and an object existing in front of the ego vehicle;
an entry prohibition area setting step of setting an entry prohibition area at least behind the object; and
a vehicle control step of controlling a speed of the ego vehicle so that a distance between the ego vehicle and the object approaches the target distance, while preventing the ego vehicle from entering into the entry prohibition area,
wherein, in the entry prohibition area setting step, setting a rear distance of the entry prohibition area which is set behind the object, based on the speed of the ego vehicle and the target distance.

According to the traveling support controller and the traveling support control method according to the present disclosure, the target distance and the rear distance of the entry prohibition area are set individually, and the speed of the ego vehicle is controlled so that the distance between the ego vehicle and the object approaches the target distance, while preventing the ego vehicle from entering into the entry prohibition area. Accordingly, when the ego vehicle does not enter into the range of the rear distance of the entry prohibition area, the speed of the ego vehicle can be controlled considering the riding comfort so that the distance approaches the target distance. When there is a possibility that the ego vehicle enters into the range of the rear distance of the entry prohibition area, the speed of the ego vehicle can be controlled so that the ego vehicle does not enter certainly into the range of the rear distance of the entry prohibition area. Since the rear distance of the entry prohibition area is set based on the speed of the ego vehicle and the target distance, the improvement of riding comfort and the certainty of collision avoidance can be balanced, considering the traveling state of the ego vehicle and the setting state of the target distance. Therefore, while certainly avoiding the collision with the obstacle in front of the ego vehicle, the excessive avoidance operation can be suppressed and the riding comfort can be improved.

### BRIEF DESCRIPTION OF THE DRAWINGS

FIG. 1 is a schematic block diagram of the traveling support controller, according to Embodiment 1;

FIG. 2 is a schematic hardware configuration figure of the traveling support controller, according to Embodiment 1;

FIG. 3 is a figure for explaining the setting of the object, according to Embodiment 1;

FIG. 4 is a figure for explaining the setting of the object, according to Embodiment 1;

FIG. 5 is a figure for explaining the setting of the object, according to Embodiment 1;

FIG. 6 is a figure for explaining the stage table data, according to Embodiment 1;

FIG. 7 is a time chart for explaining the control behavior, according to Embodiment 1;

FIG. 8 is a flowchart for explaining schematic processing of the traveling support controller, according to Embodiment 1;

FIG. 9 is a time chart for explaining the control behavior, according to Embodiment 2;

FIG. 10 is a schematic block diagram of the traveling support controller, according to Embodiment 3;

FIG. 11 is a time chart for explaining the control behavior, according to Embodiment 3; and

FIG. 12 is a flowchart for explaining schematic processing of the traveling support controller, according to Embodiment 3.

### DETAILED DESCRIPTION OF THE EMBODIMENTS

### 1. Embodiment 1

A traveling support controller 50 according to Embodiment 1 will be explained with reference to drawings. In the present embodiment, the traveling support controller 50 is provided in an ego vehicle.

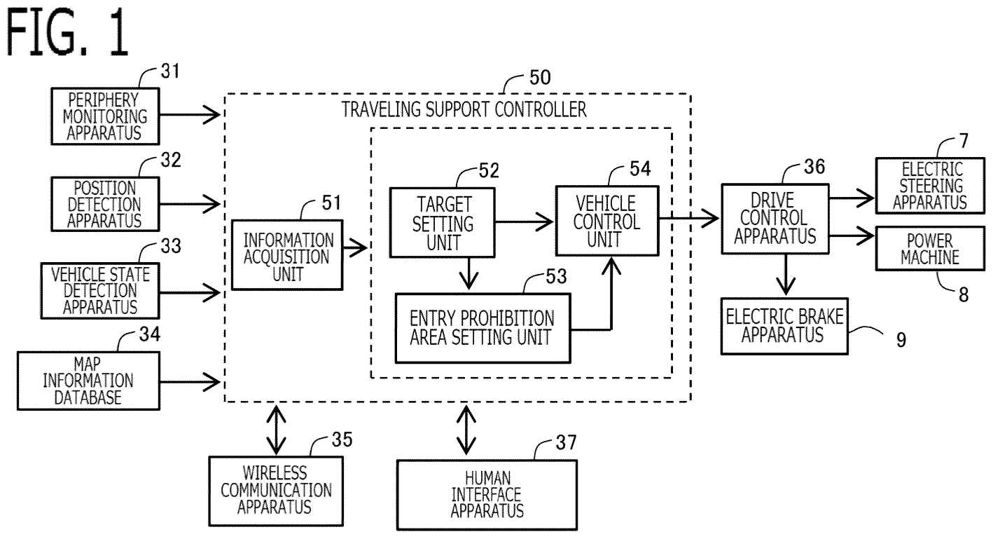

As shown in FIG. 1, the ego vehicle is provided with a periphery monitoring apparatus 31, a position detection apparatus 32, a vehicle state detection apparatus 33, a map information database 34, a wireless communication apparatus 35, a traveling support controller 50, a drive control apparatus 36, a power machine 8, an electric steering apparatus 7, an electric brake apparatus 9, a human interface apparatus 37, and the like.

The periphery monitoring apparatus 31 is an apparatus which monitors the periphery of the ego vehicle, such as a camera and a radar. As the radar, a millimeter wave radar, a laser radar, an ultrasonic radar, and the like are used. The wireless communication apparatus 35 performs a wireless communication with a base station or a peripheral equipment, using the wireless communication standard of cellular communication system, such as 4G and 5G. The wireless communication apparatus 35 performs a wireless communication with a roadside machine, a peripheral vehicle, and the like.

The position detection apparatus 32 is an apparatus which detects the present position (latitude, longitude, altitude) of the ego vehicle, and a GPS antenna which receives the signal outputted from satellites, such as GNSS (Global Navigation Satellite System), is used. For detection of the present position of the ego vehicle, various kinds of methods, such as the map matching method, the dead reckoning method, and the method using the detection information around the ego vehicle, may be used.

In the map information database 34, road information, such as a road shape (for example, a lane number, a position of each lane, a shape of each lane, a type of each lane, a road type, a limit speed, a shape of crossing point, and the like), a road sign (a limit speed sign and its limit speed, a stop sign, and the like), a road marking (a stop line, a pedestrian crossing, and the like), a tollgate (an entrance position of tollgate, a passing speed of tollgate, and the like), and a traffic signal, is stored. The map information database 34 is mainly constituted of a storage apparatus. The map information database 34 may be provided in a server outside the vehicle connected to the network, and the traveling support controller 50 may acquire required road information from the server outside the vehicle via the wireless communication apparatus 35.

As the drive control apparatus 36, a power controller, a brake controller, an automatic steering controller, a light controller, and the like are provided. The power controller controls output of a power machine 8, such as an internal combustion engine and a motor. The brake controller controls brake operation of the electric brake apparatus 9. The automatic steering controller controls the electric steering apparatus 7. The light controller controls a direction indicator, a hazard lamp, and the like.

The vehicle state detection apparatus 33 is a detection apparatus which detects an ego vehicle state, such as a driving state and a traveling state of the ego vehicle. In the present embodiment, the vehicle state detection apparatus 33 detects a speed, an acceleration, a yaw rate, a steering angle, a lateral acceleration and the like of the ego vehicle, as the traveling state of the ego vehicle. For example, as the vehicle state detection apparatus 33, a speed sensor which detects a rotational speed of wheels, an acceleration sensor, an angular speed sensor, a steering angle sensor, and the like are provided.

As the driving state of the ego vehicle, an acceleration or deceleration operation, a steering angle operation, and a lane change operation by a driver are detected. For example, as the vehicle state detection apparatus 33, an accelerator position sensor, a brake position sensor, a steering angle sensor (handle angle sensor), a steering torque sensor, a direction indicator position switch, and the like are provided.

The human interface apparatus 37 is an apparatus which receives input of the driver or transmits information to the driver, such as a loudspeaker, a display screen, an input device, and the like.

### 1-1. Traveling Support Controller 50

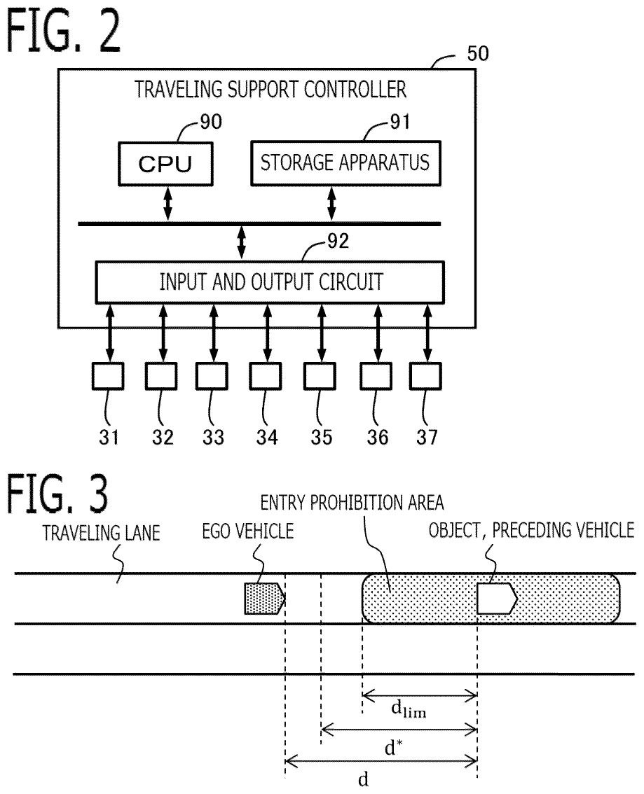

The traveling support controller 50 is provided with processing units, such as an information acquisition unit 51, a target setting unit 52, an entry prohibition area setting unit 53, a vehicle control unit 54, and the like. Each processing of the traveling support controller 50 is realized by processing circuits provided in the traveling support controller 50. As shown in FIG. 2, specifically, the traveling support controller 50 is provided with an arithmetic processor 90 such as CPU (Central Processing Unit), storage apparatuses 91, an input and output circuit 92 which outputs and inputs external signals to the arithmetic 90, and the like.

As the arithmetic processor 90, ASIC (Application Specific Integrated Circuit), IC (Integrated Circuit), DSP (Digital Signal Processor), FPGA (Field Programmable Gate Array), GPU (Graphics Processing Unit), AI (Artificial Intelligence) chip, various kinds of logical circuits, various kinds of signal processing circuits, and the like may be provided. As the arithmetic processor 90, a plurality of the same type ones or the different type ones may be provided, and each processing may be shared and executed. As the storage apparatuses 91, various kinds of storage apparatuses, such as RAM (Random Access Memory), ROM (Read Only Memory), a flash memory, EEPROM (Electrically Erasable Programmable Read Only Memory), and a hard disk, are used.

The input and output circuit 92 is provided with a communication device, an A/D converter, an input/output port, a driving circuit, and the like. The input and output circuit 92 is connected to the periphery monitoring apparatus 31, the position detection apparatus 32, the vehicle state detection apparatus 33, the map information database 34, the wireless communication apparatus 35, the drive control apparatus 36, and the human interface apparatus 37, and communicates with these devices.

Then, the arithmetic processor 90 runs software items (programs) stored in the storage apparatus 91 and collaborates with other hardware devices in the traveling support controller 50, such as the storage apparatus 91, and the input and output circuit 92, so that the respective processings of the processing units 51 to 54 provided in the traveling support controller 50 are realized. Setting data, such as the stage table data, utilized in the processing units 51 to 54 are stored in the storage apparatus 91, such as EEPROM.

### 1-1-1. Information Acquisition Unit 51

The information acquisition unit 51 acquires information on the ego vehicle, and information on an object which exists around the ego vehicle. The object is set to an object or a mark which exists in front of the ego vehicle.

For example, as shown in FIG. 3, the object is set to other vehicle (hereinafter, referred to as a preceding vehicle) which is traveling in front of the traveling lane where the ego vehicle is traveling.

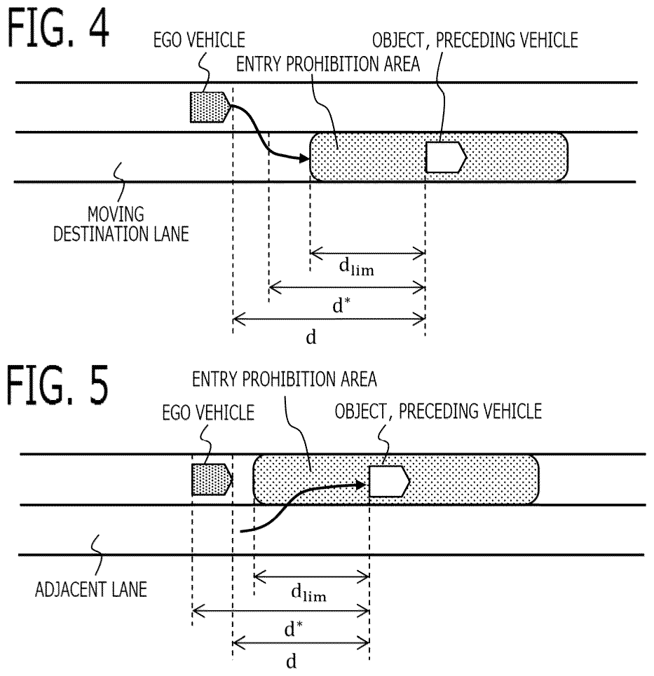

As shown in FIG. 4, the object is set to other vehicle (the preceding vehicle) which is traveling in front of a lane to which the ego vehicle is moving. In this case, there are cases such as when changing lanes, when merging lanes, and when branching lanes.

As shown in FIG. 5, the object is set to other vehicle (the preceding vehicle) which moves in front of the ego vehicle from the adjacent lane. In this case, there are cases such as when changing lanes, when merging lanes, and when branching lanes.

In the present embodiment, the information acquisition unit 51 acquires at least a speed v of the ego vehicle, a speed vtgt of the object, a distance d which is a distance between the ego vehicle and the object, and a relative speed vrel of the object with respect to the ego vehicle. The relative speed vrel is a relative speed obtained by subtracting the speed v of the ego vehicle from the speed vtgt of the object (vrel=vtgt−v).

The information acquisition unit 51 acquires a traveling state of the ego vehicle, as the information on the ego vehicle. In the present embodiment, the information acquisition unit 51 acquires a position, a moving direction, a speed, an acceleration, and the like of the ego vehicle, based on position information of the ego vehicle acquired from the position detection apparatus 32, and the ego vehicle state acquired from the vehicle state detection apparatus 33.

The information acquisition unit 51 acquires road information around the ego vehicle from the map information database 34, based on the position information of the ego vehicle acquired from the position detection apparatus 32. The acquired road information includes the road shape (for example, the lane number, the position of each lane, the shape of each lane, the type of each lane, the road type, the limit speed, the shape of crossing point, and the like), the road sign (the limit speed sign and its limit speed, the stop sign, and the like), the road marking (the stop line, the pedestrian crossing, and the like), the tollgate (the entrance position of tollgate, the passing speed of tollgate, and the like), the traffic signal, and the like. The shape of each lane includes a center position of lane, a width of lane, a curvature of lane, and the like. The shape of lane is set at each point along the longitudinal direction of the lane. The type of each lane includes a main lane, a merging lane which merges into the main lane, and the like. The shape of lane includes a start position of the merging lane, an end position of the merging lane, and a length of the merging lane.

The information acquisition unit 51 detects a shape and a type of a lane marking and the like of the road, based on the detection information on the lane marking, such as a white line and a road shoulder, acquired from the periphery monitoring apparatus 31; and determines the shape and the position of each lane, the lane number, the type of each lane, and the like, based on the detected shape and the detected type of the lane marking of the road. The shape of each lane includes the center position of lane, the width of lane, the curvature of lane, and the like. The type of each lane includes the main lane, the merging lane, and the like.

The information acquisition unit 51 acquires information on the road sign, the road marking, the traffic signal, and the tollgate, based on the detection information acquired from the periphery monitoring apparatus 31. The information acquisition unit 51 may acquire the present state of the traffic signal and the like via the wireless communication from the outside.

The information acquisition unit 51 acquires information on other vehicle around the ego vehicle. In the present embodiment, the information acquisition unit 51 acquires a relative position, a relative speed, and a distance of other vehicle with respect to the ego vehicle, and a position, a moving direction, a speed, and an acceleration of other vehicle, based on the detection information acquired from the periphery monitoring apparatus 31, and the position information on the ego vehicle acquired from the position detection apparatus 32. The information acquisition unit 51 also acquires information of an obstacle, a pedestrian, a traffic regulation such as lane regulation, and the like, other than other vehicle.

The information acquisition unit 51 may acquire the traveling state of other vehicle (the position, the moving direction, the speed, and the like of other vehicle), and the road information (the lane information and the like) and the traffic information (the obstacle, the congestion degree, and the like) around the ego vehicle, from the outside of the ego vehicle by communication. For example, the information acquisition unit 51 may acquire the movement information of other vehicle, and the road information and the traffic information around the ego vehicle, from other vehicle or the server to which other vehicle uploaded information, by the wireless communication and the like. The information acquisition unit 51 may acquire the traveling state of other vehicle, the road information, the traffic information, and the like in a monitor area, from the roadside machine, such as a camera, which monitors the condition of the road, and the like, by the wireless communication and the like.

The information acquisition unit 51 acquires the lane information corresponding to a lane where the ego vehicle is traveling, based on the position of the ego vehicle. The information acquisition unit 51 acquires the lane information corresponding to a lane where each other vehicle is traveling, based on the position of each other vehicle. The acquired lane information includes the shape, the position, and the type of lane and the lane information of the peripheral lane.

### 1-1-2. Target Setting Unit 52

The target setting unit 52 calculates a target distance d* between the ego vehicle and the object which exists in front of the ego vehicle.

In the present embodiment, the target setting unit 52 sets the target distance d*, based on the speed v of the ego vehicle, or the speed vtgt of the object. The equation (1) is used if the speed v of the ego vehicle is used, and the equation (2) is used if the speed vtgt of the object is used.

$$[ Math . 1 ]$$

$${d}^{*} = {T}_{hw} v + {D}_{stop} \qquad ( 1 )$$

$$[ Math . 2 ]$$

$${d}^{*} = {T}_{hw} {v}_{tgt} + {D}_{stop} \qquad ( 2 )$$

Herein, Thw is a time headway. Dstop is a target distance when the object stops, and is referred to as a stopping distance.

In the present embodiment, by referring a stage table data in which a relation between a plurality of stages of a degree of length of the target distance, and a plurality of default values of time headways and a plurality of default values of stopping distances preliminarily set corresponding to each of the plurality of stages, the target setting unit 52 reads the default value of the time headway and the default value of stopping distance corresponding to the stage presently set, and sets them as the time headway Thw and the stopping distance Dstop.

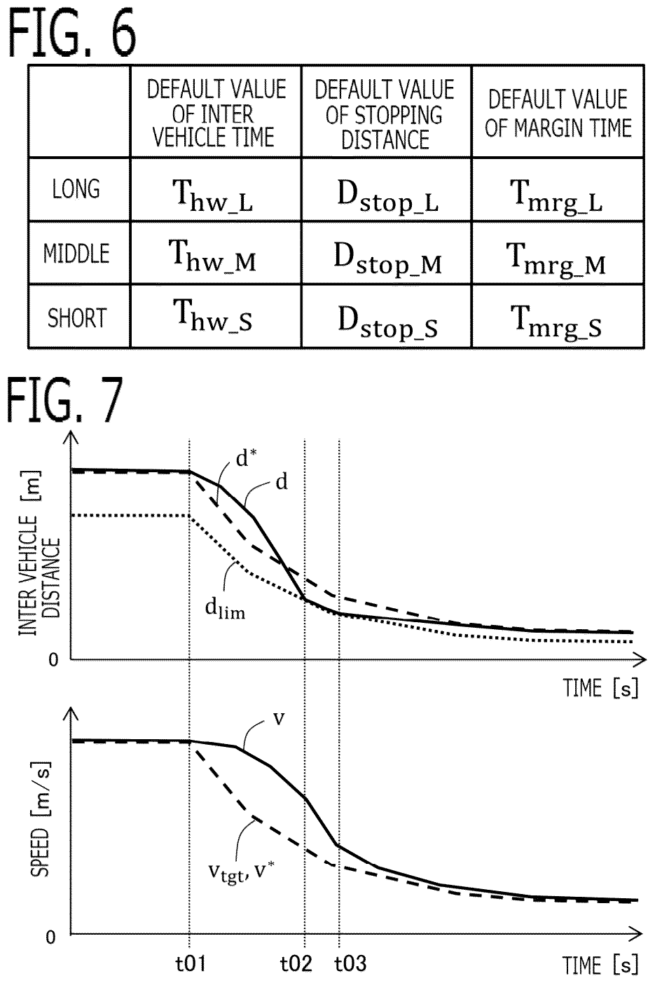

For example, as shown in FIG. 6, the plurality of stages are set to short, middle, and long. In the stage table data, three default values of time headways Thw_L, Thw_M, Thw_S, and tree default values of stopping distances Dstop_L, Dstop_M, Dstop_S are set corresponding to the three stages. Herein, Thw_L>Thw_M>Thw_S, and Dstop_L>Dstop_M>Dstop_S.

In the present embodiment, the target setting unit 52 sets a target speed v* of the ego vehicle, based on the speed vtgt of the object. For example, as shown in the next equation, the target setting unit 52 sets the target speed v* of the ego vehicle to the speed vtgt of the object. For example, the speed vtgt of the object is calculated by adding the relative speed vrel of the object with respect to the ego vehicle, to the speed v of the ego vehicle.

$$[ Math . 3 ]$$

$${v}^{*} = {v}_{tgt} = v + {v}_{rel} \qquad ( 3 )$$

### 1-1-3. Entry Prohibition Area Setting Unit 53

The entry prohibition area setting unit 53 sets an entry prohibition area at least behind the object. The entry prohibition area setting unit 53 sets a rear distance dlim of the entry prohibition area which is set behind the object, based on the speed v of the ego vehicle, and the target distance d*.

The entry prohibition area setting unit 53 sets the rear distance dlim of the entry prohibition area smaller than the target distance d*, and enlarges a decrease amount of the rear distance dlim of the entry prohibition area with respect to the target distance d*, as the speed v of the ego vehicle increases.

In the present embodiment, as shown in the next equation, the entry prohibition area setting unit 53 sets a distance obtained by subtracting a distance obtained by multiplying the margin time Tmrg to the speed v of the ego vehicle, from target distance d*, as the rear distance dlim of the entry prohibition area.

$$[ Math . 4 ]$$

$${d}_{lim} = {d}^{*} - {T}_{mrg} v \qquad ( 4 )$$

The rear distance dlim of the entry prohibition area can be shorter than the target distance d* by the multiplication distance between the speed v of the ego vehicle and the margin time Tmrg.

In the present embodiment, by referring the stage table data in which a relation between a plurality of stages of a degree of length of the target distance, and a plurality of default values of margin time preliminarily set corresponding to each of the plurality of stages is set, the entry prohibition area setting unit 52 reads the default value of margin time corresponding to the stage presently set, and sets it as the margin time Tmrg.

For example, as shown in FIG. 6, the plurality of stages are set to short, middle, and long. In the stage table data, three default values of margin times Tmrg_L, Tmrg_M, Tmrg_S are set corresponding to three stages. Herein, Tmrg_L>Tmrg_M>Tmrg_S. Alternatively, such as Tmrg_L/Thw_L>Tmrg_M/Thw_M>Tmrg_S/Thw_S, a ratio of the margin time Tmrg with respect to the time headway Thw may be set to increase as the time headway Thw increases.

### 1-1-4. Vehicle Control Unit 54

The vehicle control unit 54 controls the speed of the ego vehicle so that the distance between the ego vehicle and the object approaches the target distance d*, while preventing the ego vehicle from entering into the entry prohibition area.

In the present embodiment, the vehicle control unit 54 calculates a distance prediction value de at each future time point, and a speed prediction value ve of the ego vehicle at each future time point, using a dynamic vehicle model representing the behavior of the ego vehicle; calculates an acceleration command value aref at each future time point, by solving an optimization problem that has an evaluation function J for evaluating a distance deviation between the target distance d* and the distance prediction value de, and a speed deviation between the target speed v* and the speed prediction value ve, under a constraint condition that the ego vehicle does not enter into a range of the rear distance dlim of the entry prohibition area; and controls the speed v of the ego vehicle based on the acceleration command value aref.

The constrained optimization problem is formulated as the next equation. The next equation expresses that the control input u which minimizes the evaluation function J is obtained. Herein, x is a vehicle state, and x0 is an initial value of the vehicle state x. x′ is a prediction value of the vehicle state x. f (x, u) is a vector valued function concerning the dynamic vehicle model. g is a constraint condition which constrains the vehicle state x and the control input u, and the optimization problem is solved while satisfying the constraint condition. The positive/negative of the evaluation function may be inverted, and it may be a maximum problem which maximizes the evaluation function.

$$[ Math . 5 ]$$

$${min}_{u} J \qquad ( 5 )$$

$$\dot{x} = f ( x , u )$$

$${x}_{0} = x ( 0 )$$

$$g ( x , u ) \leq 0$$

The vehicle state x and the control input u are set as the next equation. Herein, de is the distance prediction value, ve is the speed prediction value of the ego vehicle, and ae is an acceleration prediction value of the ego vehicle. [ . . . ]^{T} expresses a transposed matrix.

$$[ Math . 6 ]$$

$$x = {[ {d}_{e} , {v}_{e} , {a}_{e} ]}^{T} \qquad ( 6 )$$

$$u = {[ {a}_{ref} ]}^{T}$$

The dynamic vehicle model can be expressed as the next equation. Herein, Ta is a response delay of the drive control apparatus with respect to the acceleration command value aref.

$$\begin{matrix}[ Math . 7 ] & \\ \dot{x} = [ \begin{matrix}{v}_{tgt} - {v}_{3} \\ {a}_{e} \\ \frac{1}{{T}_{a}} ( {a}_{ref} - {a}_{e} )\end{matrix} ] & ( 7 )\end{matrix}$$

The vehicle control unit 54 calculates the distance prediction value de and the speed prediction value ve of the ego vehicle from the present time point t=0 to the future time point ahead by the prediction period Th, using the dynamic vehicle model. The vehicle control unit 54 solves the optimization problem that calculates the control input u which minimizes the evaluation function J for evaluating each of the distance deviation and the speed deviation, at every predetermined calculation period Tper, under the constraint condition that the ego vehicle does not enter into the range of the rear distance dlim of the entry prohibition area, and calculates the solution as the acceleration command value aref.

In this case, the number of prediction time points is N. The number of time points N is calculated by N=Th/Tper. The period from the present time point t=0 to the future time point ahead by the prediction period Th is called “horizon”.

The evaluation function J is expressed as the next equation. Herein, h (k) is a vector valued function concerning evaluation items at each prediction time point k (k=0, . . . , N−1). h (N) is a vector valued function concerning the evaluation items at the prediction time point N. r (k) is target values at each prediction time point k (k=0, . . . , N−1). r (N) is target values at the prediction time point N. W and WN are weight matrices which are diagonal matrices having weights for respective evaluation items in diagonal components.

$$\begin{matrix}[ Math . 8 ] & \\ & ( 8 )\end{matrix}$$

$$J = {( h ( N ) - r ( N ) )}^{T} {W}_{N} ( h ( N ) - r ( N ) ) + {\sum }_{k = 0}^{N - 1} {( h ( k ) \to r ( k ) )}^{T} W ( h ( k ) - r ( k ) )$$

The vehicle control unit 54 sets the vector valued functions h (k) and h (N) concerning the evaluation items as the next equation, respectively. Herein, de (k) is the distance prediction value de at each prediction time point k (k=0, . . . , N). ve (k) is the speed prediction value ve of the ego vehicle at each prediction time point k (k=0, . . . , N). aref (k) is the acceleration command value at each prediction time point k (k=0, . . . , N).

$$\begin{matrix}[ Math . 9 ] & \\ h ( k ) = {[ {d}_{e} ( k ) , {v}_{e} ( k ) , {a}_{ref} ( k ) ]}^{T} & ( 9 )\end{matrix}$$

$$h ( N ) = {[ {d}_{e} ( N ) , {v}_{e} ( N ) ]}^{T}$$

The vehicle control unit 54 sets the target value r (k) and r (N) for the vector valued functions h and hN concerning the evaluation items, using the target distance d* and the target speed v* of the ego vehicle.

$$\begin{matrix}[ Math . 10 ] & \\ r ( k ) = {[ {d}^{*} , {v}^{*} , 0 ]}^{T} & ( 10 )\end{matrix}$$

$$r ( N ) = {[ {d}^{*} , {v}^{*} ]}^{T}$$

As shown in the next equation, the vehicle control unit 54 sets the constraint condition such that the distance prediction value de (k) at each prediction time point k becomes greater than or equal to the rear distance dlim so that the ego vehicle does not enter into the range of the rear distance dlim of the entry prohibition area.

$$\begin{matrix}[ Math . 11 ] & \\ g ( k ) = {d}_{lim} - {d}_{e} ( k ) \leq 0 & ( 11 )\end{matrix}$$

The vehicle control unit 54 evaluates a deviation between the vector valued function h (k) and the target value r (k), and a deviation between the vector valued function h (N) and the target value r (N), using the evaluation function J. The vehicle control unit 54 solves the optimization problem that calculates the control input u which minimizes the evaluation value of each deviation, at every predetermined calculation period, under the constraint condition that the ego vehicle does not enter into the range of the rear distance dlim of the entry prohibition area, and sets the acceleration command value aref (k) at each prediction time point k of the obtained solution, as the acceleration command value aref (t) at each future time point t. Since the processing itself which solves the optimization problem is well-known technology, detailed explanation is omitted.

The vehicle control unit 54 sets the acceleration command value aref corresponding to the present time point, from the acceleration command value aref (t) at each future time point t; and calculates an output command value of the power machine 8, and a braking force command value of the electric brake apparatus 9, based on the acceleration command value aref, and transmits each command value to the power controller and the brake controller.

The power controller controls the output of the power machines 8, such as the internal combustion engine and the motor, according to the output command value. The brake controller controls the brake operation of the electric brake apparatus 9 according to the braking force command value.

### <Control Behavior>

FIG. 7 shows an example of control behavior. The upper graph of FIG. 7 shows the information concerning the distance between the ego vehicle and the object (preceding vehicle). The lower graph of FIG. 7 shows the information concerning the speed of the ego vehicle. Until the time t01, the ego vehicle and the preceding vehicle are traveling at the constant speed, and the distance d between the ego vehicle and the preceding vehicle is maintained at the target distance d*. The rear distance dlim of the entry prohibition area is set shorter than the target distance d* by the multiplication distance between the speed v of the ego vehicle and the margin time Tmrg.

The preceding vehicle decelerates rapidly from the time t01. In the example of FIG. 7, the target distance d* is set in proportion to the speed vtgt of the preceding vehicle using the equation (2). Accordingly, the target distance d* is decreased in proportion to the speed vtgt of the preceding vehicle, and the rear distance dlim of the entry prohibition area is decreased according to the decrease of the speed vtgt of the preceding vehicle. The target speed v* of the ego vehicle is set to the speed vtgt of the preceding vehicle. Accordingly, the target speed v* is decreased similar to the deceleration of the speed vtgt of the preceding vehicle.

After the start of rapid deceleration of the preceding vehicle, without being limited by the constraint condition of the rear distance dlim of the entry prohibition area, the acceleration command value aref is decreased so that the speed v and the distance d of the ego vehicle follows the target speed v* and the target distance d*, and the speed v and the distance d of the ego vehicle decreases. However, due to the following delay, the speed v of the ego vehicle exceeds the target speed v* and the speed vtgt of the preceding vehicle, and the distance d exceeds the target distance d*. Since the distance d becomes an integration value of the relative speed between the speed v of the ego vehicle and the speed vtgt of the preceding vehicle, the decrease amount of the distance d with respect to the target distance d* increases with a delay after the start of deceleration of the preceding vehicle, and the distance d decreases to the rear distance dlim of the entry prohibition area at the time t02.

After the time t02, since the acceleration command value aref is calculated by being limited to the constraint condition of the rear distance dlim of the entry prohibition area, the acceleration command value aref is calculated such that the ego vehicle does not enter into the range of the rear distance dlim of the entry prohibition area. Accordingly, the acceleration command value aref is further decreased and the speed v of the ego vehicle further decreases.

After the time t03, the distance d starts to exceed the rear distance dlim of the entry prohibition area, and the speed v of the ego vehicle and the distance d gradually converge to the target speed v* and target distance d*.

At the time t02, since a while has elapsed after the start of the deceleration of the preceding vehicle and the deceleration of the ego vehicle, and the deceleration of the ego vehicle is progressing, even if the deceleration is performed such that the ego vehicle does not enter into the range of the rear distance dlim of the entry prohibition area, the driver will not feel a large uncomfortable feeling. Therefore, while avoiding the collision with the preceding vehicle certainly, the control with good riding comfort without excessive reaction to the deceleration of the preceding vehicle can be achieved.

### 1-1-5. Flowchart

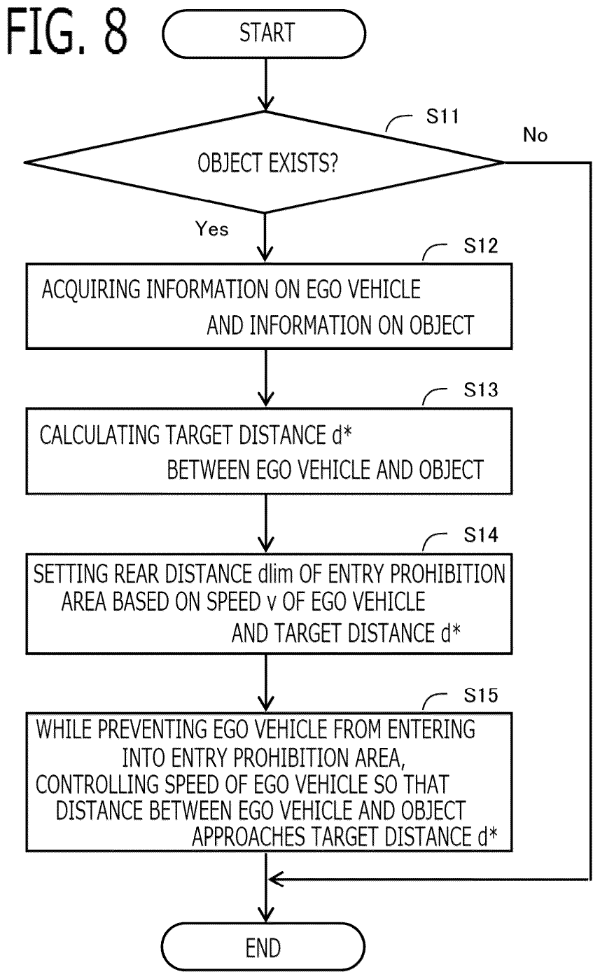

Next, using the flowchart shown in FIG. 8, the procedure of schematic processing of the traveling support controller 50 (a traveling support control method) according to the present embodiment will be explained. The processing of the flowchart of FIG. 8 is executed at every predetermined calculation period, for example. The processing of unnecessary step at the execution time point is skipped appropriately.

In the step S11, as mentioned above, the information acquisition unit 51 determines whether or not an object for controlling the distance exists around the ego vehicle. When existing, it advances to the step S12, and when not existing, the processing is ended.

In the step S12, as mentioned above, the information acquisition unit 51 acquires information on the ego vehicle, and information on an object which exists around the ego vehicle.

In the step S13, as mentioned above, the target setting unit 52 calculates the target distance d* between the ego vehicle and the object which exists in front of the ego vehicle. The target setting unit 52 sets the target speed v* of the ego vehicle, based on the speed vtgt of the object.

In the step S14, as mentioned above, the entry prohibition area setting unit 53 sets the entry prohibition area at least behind the object. The entry prohibition area setting unit 53 sets the rear distance dlim of the entry prohibition area which is set behind the object, based on the speed v of the ego vehicle, and the target distance d*.

In the step S15, as mentioned above, the vehicle control unit 54 controls the speed of the ego vehicle so that the distance between the ego vehicle and the object approaches the target distance d*, while preventing the ego vehicle from entering into the entry prohibition area.

### 2. Embodiment 2

Next, the traveling support controller 50 according to Embodiment 2 will be explained. The explanation for constituent parts the same as those in Embodiment 1 will be omitted. The basic configuration of the traveling support controller 50 according to the present embodiment is the same as that of Embodiment 1. The setting method of the rear distance dlim of the entry prohibition area is different from Embodiment 1.

In the present embodiment, the entry prohibition area setting unit 53 lengthens the rear distance dlim of the entry prohibition area, as a relative speed vrel of the object obtained by subtracting the speed v of the ego vehicle from the speed vtgt of the object increases in a negative direction; and shortens the rear distance dlim of the entry prohibition area, as the relative speed vrel increases in a positive direction.

According to this configuration, as the relative speed vrel increases in the negative direction and a decreasing speed of the distance d increases, the rear distance dlim of the entry prohibition area is lengthened, whereby the ego vehicle can be decelerated in an early stage, the distance d is secured, and the collision with the object can be prevented more certainly. By starting the deceleration in an early stage, the peak of deceleration can be suppressed and the riding comfort can be improved. On the other hand, as the relative speed vrel increase in the positive direction and an increasing speed of the distance d increases, the possibility of the collision with the object decreases. Accordingly, even if the rear distance dlim of the entry prohibition area is shortened, there is no possibility of collision with the object.

The entry prohibition area setting unit 53 lengthens the rear distance dlim of the entry prohibition area, as the relative acceleration arel of the object obtained by subtracting the acceleration a of the ego vehicle from the acceleration atgt of the object increases in a negative direction; and shortens the rear distance dlim of the entry prohibition area, as the relative acceleration arel increases in a positive direction.

According to this configuration, as the relative acceleration arel increases in the negative direction and a decreasing acceleration of the distance d increases, the rear distance dlim of entry prohibition area is lengthened, whereby the ego vehicle can be decelerated in an early stage, the distance d is secured, and the collision with the object can be prevented more certainly. By starting the deceleration in an early stage, the peak of deceleration can be suppressed and the riding comfort can be improved. On the other hand, as the relative acceleration arel increases in the positive direction and an increasing acceleration of the distance d increases, the possibility of the collision with the object decreases. Accordingly, even if the rear distance dlim of the entry prohibition area is shortened, there is no possibility of collision with the object.

In the present embodiment, using the next equation, the entry prohibition area setting unit 53 sets the rear distance dlim of the entry prohibition area. Herein, kv is a coefficient for relative speed and is set to a negative value. ka is a coefficient for relative acceleration and is set to a negative value.

$$\begin{matrix}[ Math . 12 ] & \\ {d}_{lim} = {d}^{*} + {k}_{v} {v}_{rel} + {k}_{a} {a}_{rel} & ( 12 )\end{matrix}$$

$${k}_{v} < 0 , {k}_{a} < 0$$

$${v}_{rel} = {v}_{tgt} - v$$

$${a}_{rel} = {a}_{tgt} - v$$

The setting of the rear distance dlim of the entry prohibition area according to the relative acceleration arel may not be performed. Instead of kv×vrel, a function, such as map data or an equation, in which a relation between the relative speed vrel and an addition value to the target distance d* is set may be used. Instead of ka×arel, a function, such as map data or an equation, in which a relation between the relative acceleration arel and an addition value to the target distance d* is set may be used.

### <Control Behavior>

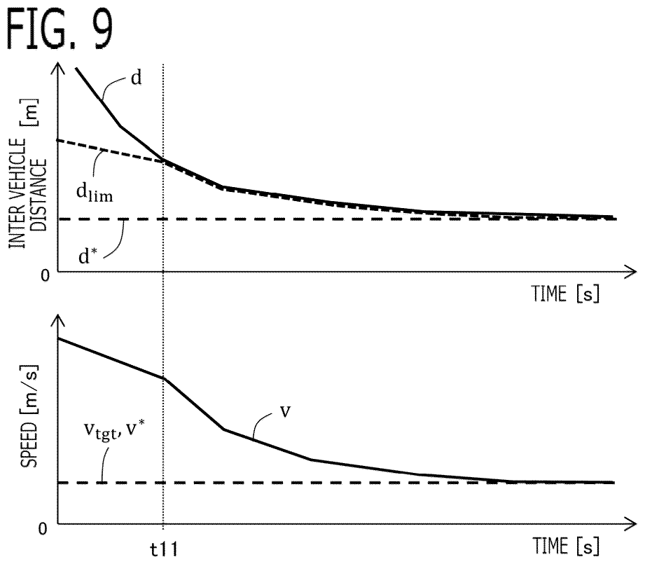

FIG. 9 shows an example of control behavior. The upper graph of FIG. 9 shows the information concerning the distance between the ego vehicle and the object (preceding vehicle). The lower graph of FIG. 9 shows the information concerning the speed of the ego vehicle. The preceding vehicle is traveling at the constant speed vtgt, the speed v of the ego vehicle is larger than the speed vtgt of the preceding vehicle, and the relative speed vrel is negative. The ego vehicle is approaching the preceding vehicle from the rear of the preceding vehicle. The target distance d* is set in proportion to the speed vtgt of the preceding vehicle using the equation (2). Since the speed vtgt of the preceding vehicle is constant, the target distance d* is constant.

Since the relative speed vrel is negative, the rear distance dlim of the entry prohibition area is larger than the target distance d* according to the magnitude of the relative speed vrel. As the speed v of the ego vehicle approaches the speed vtgt of the preceding vehicle and the magnitude of the relative speed vrel decreases, the increase amount of the rear distance dlim of the entry prohibition area with respect to the target distance d* is decreasing.

At the time t11, the distance d decreases to the rear distance dlim of the entry prohibition area. After the time t11, since the acceleration command value aref is calculated by being limited to the constraint condition of the rear distance dlim of the entry prohibition area, the acceleration command value aref is increased to the negative direction so that the ego vehicle does not enter into the range of the rear distance dlim of the entry prohibition area, and the speed v of the ego vehicle further decreases. Accordingly, the ego vehicle can be decelerated in an early stage so that the distance d with respect to the magnitude of the relative speed vrel does not decrease too much, the distance d is secured, and the collision with the object can be prevented more certainly. By starting the deceleration in an early stage, the peak of deceleration can be suppressed and the riding comfort can be improved.

### 3. Embodiment 3

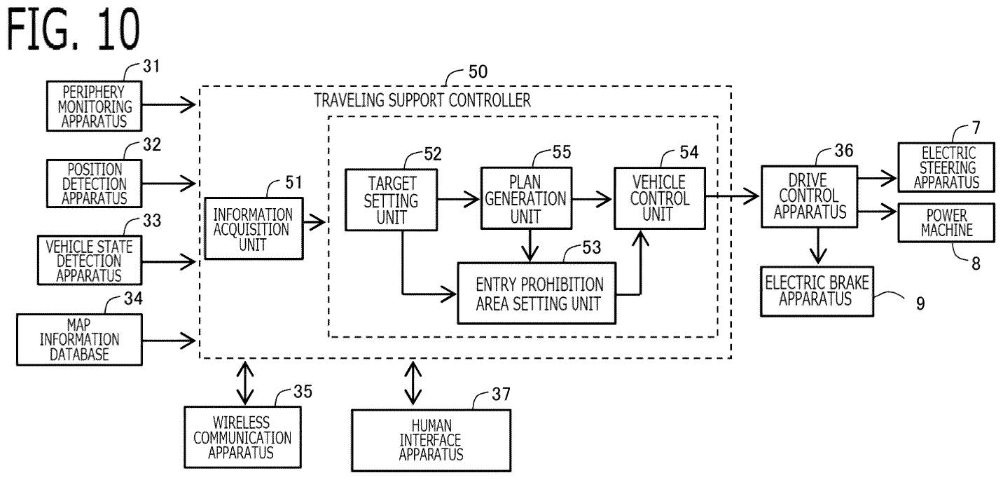

Next, the traveling support controller 50 according to Embodiment 3 will be explained. The explanation for constituent parts the same as those in Embodiment 1 will be omitted. The basic configuration of the traveling support controller 50 according to the present embodiment is the same as that of Embodiment 1. The plan generation unit 55 is further provided, and accordingly, the processing of the entry prohibition area setting unit 53 and the vehicle control unit 54 is different from Embodiment 1. FIG. 10 shows the block diagram of the traveling support controller 50 according to the present embodiment.

### <Plan Generation Unit 55>

The plan generation unit 55 calculates a transitional target distance dplan* (t) at each future time point t until the distance d reaches the target distance d*, and a transitional target speed vplan* (t) at each future time point t until the speed v of the ego vehicle reaches the target speed v*.

In the present embodiment, the plan generation unit 55 performs a filter processing to the target distance d* in a virtual time representing each future time point t from the present to a future time point ahead by a planning period, and calculates the transitional target distance dplan* (t) at each future time point t.

For example, the calculation shown in the next equation is performed. Herein, s is Laplace operator, F (s) is a transfer function representing the filter processing, d* (s) represents the target distance d* after Laplace transformation, and L⁻¹ represents an inverse Laplace transform. The discretized equation is used for the actual arithmetic equation.

$$\begin{matrix}[ Math . 13 ] & \\ {d}_{plan}^{*} ( t ) = {ℒ}^{- 1} [ F ( s ) {d}^{*} ( s ) ] & ( 13 )\end{matrix}$$

Various kinds of low pass filter processings are used for the filter processing. For example, moving average processings of multiple stages (for example, three stages or four stages) are used for the filter processing.

In the present embodiment, the plan generation unit 55 calculates the transitional target speed vplan* (t) at each future time point t, based on a time differential value of the transitional target distance dplan* (t) at each future time point t, and the target speed v*, in the virtual time representing each future time point t from the present to the future time point ahead by the planning period.

For example, the calculation shown in the next equation is performed. Herein, s represents a differential operation. The discretized equation is used for the actual arithmetic equation.

$$\begin{matrix}[ Math . 14 ] & \\ {v}_{plan}^{*} ( t ) = - {ℒ}^{- 1} [ sF ( s ) {d}^{*} ( s ) ] + {v}^{*} & ( 14 )\end{matrix}$$

The plan generation unit 55 calculates a time differential value of an initial output value of the filter processing at the present time point t=0 such that the transitional target speed vplan* (0) at the present time point t=0 coincides with the present speed v of the ego vehicle; calculates the initial output value of the filter processing at the present time point t=0 such that the transitional target distance dplan* (0) at the present time point t=0 coincides with the present distance d; and sets an initial internal arithmetic value of the filter processing such that the time differential value of the output value of the filter processing coincides with the time differential value of the initial output value, and the output value of the filter processing coincides with the initial output value, at the present time point t=0.

The calculation of the transitional target distance dplan* and the transitional target speed vplan* is executed, for example, when the object is newly set, when the state of the object is changed, or when the specific condition is established.

### <Entry Prohibition Area Setting Unit 53>

The entry prohibition area setting unit 53 calculates the rear distance dlim (t) of the entry prohibition area at each future time point t, based on the target distance d* and the transitional target distance dplan* (t) at each future time point t.

In the present embodiment, as shown in the next equation, the entry prohibition area setting unit 53 sets smaller one of the target distance d* and the transitional target distance dplan* (t) at each future time point t, as the rear distance dlim (t) of the entry prohibition area at each future time point t.

$$\begin{matrix}[ Math . 15 ] & \\ {d}_{lim} ( t ) = min ( {d}^{*} , {d}_{plan}^{*} ( t ) ) & ( 15 )\end{matrix}$$

Alternatively, as shown in the next equation, the entry prohibition area setting unit 53 may set a distance obtained by subtracting a distance obtained by multiplying the margin time Tmrg to the speed v of the ego vehicle, from smaller one of the target distance d* and the transitional target distance dplan* (t) at each future time point t, as the rear distance dlim (t) of the entry prohibition area at each future time point t.

$$\begin{matrix}[ Math . 16 ] & \\ {d}_{lim} ( t ) = min ( {d}^{*} , {d}_{plan}^{*} ( t ) ) - {T}_{mrg} v & ( 16 )\end{matrix}$$

### <Vehicle Control Unit 54>

In the present embodiment, the vehicle control unit 54 controls the speed v of the ego vehicle so that the distance d approaches the transitional target distance dplan* at each future time point, and the speed v of the ego vehicle approaches the transitional target speed vplan* at each future time point, while preventing the ego vehicle from entering into the range of the rear distance dlim of the entry prohibition area at each future time point.

In the present embodiment, the vehicle control unit 54 calculates a distance prediction value de at each future time point, and a speed prediction value ve of the ego vehicle at each future time point, using a dynamic vehicle model representing the behavior of the ego vehicle; calculates an acceleration command value aref at each future time point, by solving an optimization problem that has an evaluation function for evaluating a distance deviation between the distance prediction value de at each future time point and the transitional target distance dplan* at each future time point, and a speed deviation between the speed prediction value ve of the ego vehicle at each future time point and the transitional target speed vplan* at each future time point, under a constraint condition that the ego vehicle does not enter into the range of the rear distance dlim of the entry prohibition area at each future time point; and controls the speed v of the ego vehicle based on the acceleration command value aref.

In the vehicle control unit 54, although the following equations are different from Embodiment 1, other equations are similar to Embodiment 1.

In the present embodiment, as shown in the next equation, the vehicle control unit 54 sets the target values r (k) and r (N) for the vector valued functions h (k) and h (N) concerning evaluation items, using the transitional target distance dplan* at each future time point, and the transitional target speed vplan* at each future time point.

$$\begin{matrix}[ Math . 17 ] & \\ r ( k ) = {[ {d}_{plan}^{*} ( k ) , {v}_{plan}^{*} ( k ) , 0 ]}^{T} & ( 17 )\end{matrix}$$

$$r ( N ) = {[ {d}_{plan}^{*} ( N ) , {v}_{plan}^{*} ( N ) ]}^{T}$$

Herein, the transitional target distance dplan* (k) at each corresponding prediction time point k is set based on the transitional target distance dplan* (t) at each future time point t; and the transitional target speed vplan* (k) at each corresponding prediction time point k is set based on the transitional target speed vplan* (t) at each future time point t.

As shown in the next equation, the vehicle control unit 54 sets the constraint condition that the distance prediction value de (k) at each prediction time point k becomes greater than or equal to the rear distance dlim (k) at each prediction time point k so that the ego vehicle does not enter into the range of the rear distance dlim of the entry prohibition area at each future time point.

$$\begin{matrix}[ Math . 18 ] & \\ g ( k ) = {d}_{lim} ( k ) - {d}_{e} ( k ) \leq 0 & ( 18 )\end{matrix}$$

Herein, the rear distance dlim (k) of the entry prohibition area at each corresponding prediction time point k is set based on the rear distance dlim (t) of the entry prohibition area at each future time point t.

### <Control Behavior>

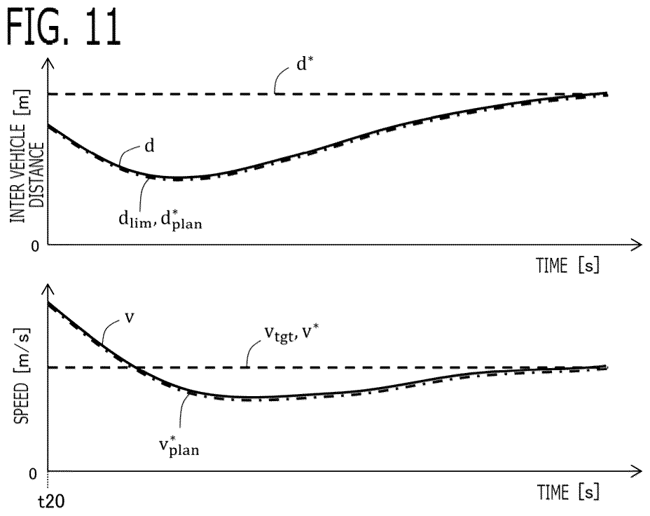

FIG. 11 shows an example of control behavior. The upper graph of FIG. 11 shows the information concerning the distance between the ego vehicle and the object (preceding vehicle). The lower graph of FIG. 11 shows the information concerning the speed of the ego vehicle. FIG. 11 shows the behavior after other vehicle changes lanes in front of the ego vehicle (cut in), as shown in FIG. 5.

At the time t20, other vehicle changes lanes in front of the ego vehicle, other vehicle is set as the object, the target distance d* is set, and the speed control is started. The target distance d* is set in proportion to the speed vtgt of the preceding vehicle using the equation (2). Since the speed vtgt of the preceding vehicle is constant, the target distance d* is constant. The target speed v* of the ego vehicle is set to the speed vtgt of the preceding vehicle.

At the time t20, the speed v of the ego vehicle is larger than the speed vtgt of the preceding vehicle. The transitional target distance dplan* at each future time point until the distance d reaches the target distance d*, and the transitional target speed vplan* at each future time point until the speed v of the ego vehicle reaches the target speed v* are calculated. The transitional target distance dplan* at each future time point is smaller than the target distance d*, and the transitional target distance dplan* at each future time point is set as the rear distance dlim of the entry prohibition area at each future time point.

Then, the acceleration command value aref is calculated, by being limited by the constraint condition of the rear distance dlim of the entry prohibition area (transitional target distance dplan*); and the acceleration command value aref is calculated such that the ego vehicle does not enter into the range of the rear distance dlim of the entry prohibition area. As a result, the distance d is controlled along with the rear distance dlim of the entry prohibition area (the transitional target distance dplan*), and the speed v of the ego vehicle is controlled along with the transitional target speed vplan*.

Since the transitional target distance dplan* which is set as the rear distance dlim of the entry prohibition area is a plan of the target distance until the distance d reaches the target distance d*, even if the transitional target distance dplan* is set as the constraint condition, excessive acceleration and deceleration of the ego vehicle is suppressed, and planned and appropriate acceleration and deceleration is performed. Accordingly, even when other vehicle cuts in front of the ego vehicle, while avoiding the collision with the preceding vehicle certainly, the control with good riding comfort without excessive acceleration and deceleration to the preceding vehicle can be achieved.

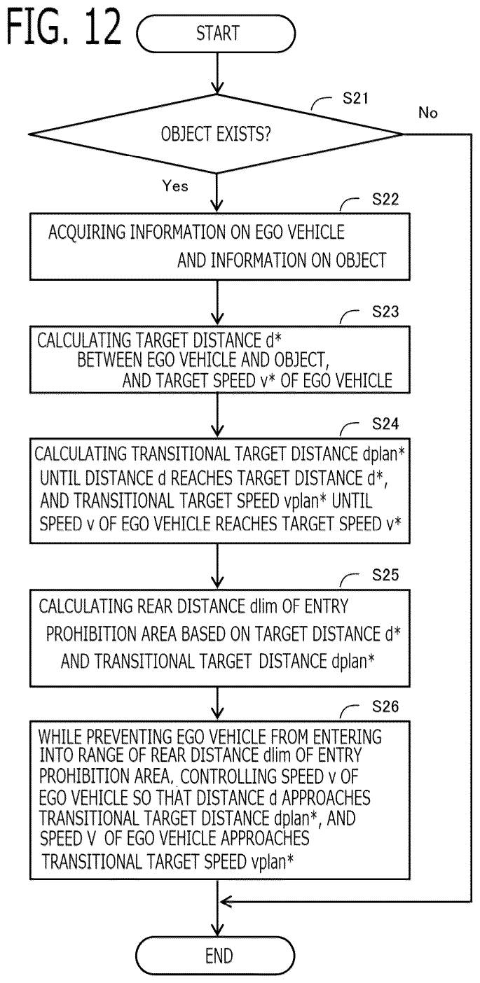

Next, using the flowchart shown in FIG. 12, the procedure of schematic processing of the traveling support controller 50 (a traveling support control method) according to the present embodiment will be explained. The processing of the flowchart of FIG. 12 is executed at every predetermined calculation period, for example. The processing of unnecessary step at the execution time point is skipped appropriately.

In the step S21, as mentioned above, the information acquisition unit 51 determines whether or not an object for controlling the distance exists around the ego vehicle. When existing, it advances to the step S22, and when not existing, the processing is ended.

In the step S22, as mentioned above, the information acquisition unit 51 acquires information on the ego vehicle, and information on an object which exists around the ego vehicle.

In the step S23, as mentioned above, the target setting unit 52 calculates a target distance d* between the ego vehicle and the object which exists in front of the ego vehicle. The target setting unit 52 sets the target speed v* of the ego vehicle, based on the speed vtgt of the object.

In the step S24, as mentioned above, the plan generation unit 55 calculates a transitional target distance dplan* (t) at each future time point t until the distance d reaches the target distance d*, and a transitional target speed vplan* (t) at each future time point t until the speed v of the ego vehicle reaches the target speed v*.

In the step S25, as mentioned above, the entry prohibition area setting unit 53 sets the entry prohibition area at least behind the object. The entry prohibition area setting unit 53 calculates the rear distance dlim (t) of the entry prohibition area at each future time point t, based on the target distance d* and the transitional target distance dplan* (t) at each future time point t.

In the step S26, as mentioned above, the vehicle control unit 54 controls the speed v of the ego vehicle so that the distance d approaches the transitional target distance dplan* at each future time point, and the speed v of an ego vehicle approaches the transitional target speed vplan* at each future time point, while preventing the ego vehicle from entering into the range of the rear distance dlim of the entry prohibition area at each future time point.

### Other Embodiments

(1) In each of the above-mentioned embodiments, the object is set to the preceding vehicle in front of the ego vehicle. However, the object may be set to various kinds of objects, such as a stop object and a stop position which exist in front of the ego vehicle. The stop object is set to a stopping vehicle, an obstacle, and the like which exist in front of an ego vehicle. The stop position is set to various kinds of stop lines (for example, the stop line, the stop line of the pedestrian crossing, the stop line of the crossing point), the stop line of the traffic signal, and the stop position due to various kinds of factors. In this case, since the speed vtgt of the object is 0, the target speed v* is set to 0.

(2) In Embodiment 3, the entry prohibition area setting unit 53 may calculate a lower limitation value Tlim (t) of the time headway at each future time point t, as an alternative parameter representing the rear distance dlim of the entry prohibition area at each future time point, based on the rear distance dlim (t) of the entry prohibition area at each future time point t and the transitional target speed vplan* (t) at each future time point t.

For example, as shown in the next equation, the entry prohibition area setting unit 53 calculates the lower limitation value Tlim (t) of the time headway at each future time point, by dividing a value obtained by subtracting the stopping distance Dstop from the rear distance dlim (t) of the entry prohibition area at each future time point t, by the transitional target speed vplan* (t) at each future time point t. The stopping distance Dstop is the target distance when the object stops.

$$\begin{matrix}[ Math . 19 ] & \\ {T}_{lim} ( k ) = \frac{{d}_{lim} ( k ) - {D}_{stop}}{{v}_{plan}^{*} ( k )} & ( 19 )\end{matrix}$$

Then, the vehicle control unit 54 controls the speed v of the ego vehicle so that the distance d approaches the transitional target distance dplan* at each future time point, and the speed v of the ego vehicle approaches the transitional target speed vplan* at each future time point, while preventing the time headway Thw of the ego vehicle calculated based on the distance d and the speed v of the ego vehicle from becoming smaller than the lower limitation value Tlim of the time headway at each future time point.

Specifically, the vehicle control unit 54 calculates a distance prediction value de at each future time point, and a speed prediction value ve of the ego vehicle at each future time point, using a dynamic vehicle model representing the behavior of the ego vehicle; calculates the acceleration command value aref at each future time point, by solving an optimization problem that has an evaluation function for evaluating a distance deviation between the distance prediction value de at each future time point and the transitional target distance dplan* at each future time point, and a speed deviation between the speed prediction value ve of the ego vehicle at each future time point and the transitional target speed vplan* at each future time point, under a constraint condition that a prediction value Thwe of the time headway of the ego vehicle at each future time point calculated based on the distance prediction value de at each future time point and the speed prediction value ve at each future time point does not become smaller than the lower limitation value Tlim (t) of the time headway at each future time point; and controls the speed of the ego vehicle based on the acceleration command value aref.

As shown in the next equation, the vehicle control unit 54 calculates the prediction value Thwe (k) of the time headway at each prediction time point k, by dividing a value obtained by subtracting the stopping distance Dstop from the distance prediction value de (k) at each prediction time point k, by the speed prediction value ve (k) at each prediction time point k.

$$\begin{matrix}[ Math . 20 ] & \\ {T}_{hwe} ( k ) = \frac{{d}_{e} ( k ) - {D}_{stop}}{{v}_{e} ( k )} & ( 20 )\end{matrix}$$

As shown in the next equation, the vehicle control unit 54 sets a constraint condition that the prediction value Thwe (k) of the time headway at each prediction time point k becomes greater than or equal to the lower limitation value Tlim (k) of the time headway at each prediction time point k so that the prediction value Thwe (k) of the time headway at each prediction time point k does not become smaller than the lower limitation value Tlim (k) of the time headway at each prediction time point k.

$$\begin{matrix}[ Math . 21 ] & \\ g ( k ) = {T}_{lim} ( k ) - {T}_{hwe} ( k ) \leq 0 & ( 21 )\end{matrix}$$

(3) In each of above embodiments, the vehicle control unit 54 solves the optimization problem, and controls the speed of the ego vehicle. In Embodiments 1 and 2, using a control method other than solving the optimization problem, the vehicle control unit 54 may control the speed v of the ego vehicle so that the distance d approaches the target distance d*, while preventing the ego vehicle from entering into the entry prohibition area. For example, while changing the acceleration command value aref by feedback control so that the distance d approaches the target distance d*, the vehicle control unit 54 may change the acceleration command value aref so that the ego vehicle does not enter into the entry prohibition area, when there is a possibility that the ego vehicle enters into the entry prohibition area.

In Embodiment 3, using a control method other than solving the optimization problem, while preventing the ego vehicle from entering into the range of the rear distance dlim of the entry prohibition area at each future time point, the vehicle control unit 54 may control the speed v of the ego vehicle so that the distance d approaches transitional target distance dplan* at each future time point, and the speed v of the ego vehicle approaches the transitional target speed vplan* at each future time point. For example, while changing the acceleration command value aref by feedback control so that the distance d approaches the transitional target distance dplan* at each future time point, and the speed v of the ego vehicle approaches the transitional target speed vplan* at each future time point, the vehicle control unit 54 may change the acceleration command value aref so that the ego vehicle does not enter into the entry prohibition area, when there is a possibility that the ego vehicle enters into the range of the rear distance dlim of the entry prohibition area at each future time point.

Although the present disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments. It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

What is claimed is:

1. A traveling support controller comprising at least one processor configured to implement:
a target distance calculator that calculates a target distance between an ego vehicle and an object existing in front of the ego vehicle;
an entry prohibition area setter that sets an entry prohibition area at least behind the object; and
a vehicle controller that controls a speed of the ego vehicle so that a distance between the ego vehicle and the object approaches the target distance, while preventing the ego vehicle from entering into the entry prohibition area,
wherein the entry prohibition area setter sets a rear distance of the entry prohibition area which is set behind the object, based on the speed of the ego vehicle and the target distance.

2. The traveling support controller according to claim 1,
wherein the entry prohibition area setter sets a distance obtained by subtracting a distance obtained by multiplying a margin time to the speed of the ego vehicle, from the target distance, as the rear distance of the entry prohibition area.

3. The traveling support controller according to claim 2,
by referring a stage table data in which a relation between a plurality of stages of a degree of length of the target distance, and a plurality of default values of margin time preliminarily set corresponding to each of the plurality of stages is set, the entry prohibition area setter reads the default value of margin time corresponding to the stage presently set, and sets it as the margin time.

4. The traveling support controller according to claim 1,
wherein the entry prohibition area setter lengthens the rear distance of the entry prohibition area, as a relative speed of the object obtained by subtracting the speed of the ego vehicle from the speed of the object increases in a negative direction; and shortens the rear distance of the entry prohibition area, as the relative speed increases in a positive direction.

5. The traveling support controller according to claim 4,
wherein the entry prohibition area setter lengthens the rear distance of the entry prohibition area, as a relative acceleration of the object obtained by subtracting the acceleration of the ego vehicle from the acceleration of the object increases in a negative direction; and shortens the rear distance of the entry prohibition area, as the relative acceleration increases in a positive direction.

6. The traveling support controller according to claim 1, wherein at least one processor configured to further implement
a plan generator that calculates a transitional target distance at each future time point until the distance reaches the target distance, and a transitional target speed at each future time point until the speed of the ego vehicle reaches a target speed, and
wherein the entry prohibition area setter calculates the rear distance of the entry prohibition area at each future time point, based on the target distance and the transitional target distance at each future time point.

7. The traveling support controller according to claim 6,
wherein the entry prohibition area setter sets smaller one of the target distance and the transitional target distance at each future time point, as the rear distance of the entry prohibition area at each future time point.

8. The traveling support controller according to claim 6,
wherein the entry prohibition area setter sets a distance obtained by subtracting a distance obtained by multiplying the margin time to the speed of the ego vehicle, from smaller one of the target distance and the transitional target distance at each future time point, as the rear distance of the entry prohibition area at each future time point.

9. The traveling support controller according to claim 6,
wherein the vehicle controller controls the speed of the ego vehicle so that the speed of the ego vehicle approaches the transitional target speed at each future time point, and the distance approaches the transitional target distance at each future time point, while preventing the ego vehicle from entering into a range of the rear distance of the entry prohibition area at each future time point.

10. The traveling support controller according to claim 6,
wherein the entry prohibition area setter calculates a lower limitation value of a time headway at each future time point, based on the rear distance of the entry prohibition area at each future time point and the transitional target speed at each future time point, as an alternative parameter representing the rear distance of the entry prohibition area at each future time point, and
wherein the vehicle controller controls the speed of the ego vehicle so that the distance approaches the transitional target distance at each future time point, and the speed of the ego vehicle approaches the transitional target speed at each future time point, while preventing the time headway of the ego vehicle calculated based on the distance and the speed of the ego vehicle from becoming smaller than the lower limitation value of the time headway at each future time point.

11. The traveling support controller according to claim 10,
wherein the entry prohibition area setter calculates the lower limitation value of the time headway at each future time point, by calculating a subtraction value obtained by subtracting a stopping distance which is a target distance when the object stops, from the rear distance of the entry prohibition area at each future time point, and dividing the subtraction value by the transitional target speed at each future time point, and
wherein the vehicle controller calculates the time headway, by dividing a value obtained by subtracting the stopping distance from the distance, by the speed of the ego vehicle.

12. A traveling support control method comprising:
a target distance calculation step of calculating a target distance between an ego vehicle and an object existing in front of the ego vehicle;
an entry prohibition area setting step of setting an entry prohibition area at least behind the object; and
a vehicle control step of controlling a speed of the ego vehicle so that a distance between the ego vehicle and the object approaches the target distance, while preventing the ego vehicle from entering into the entry prohibition area,
wherein, in the entry prohibition area setting step, setting a rear distance of the entry prohibition area which is set behind the object, based on the speed of the ego vehicle and the target distance.
